(19) United States
(12) Patent Application Publication
(10) Pub. No.: US 2005/0152412 A1
(43) Pub. Date: Jul. 14, 2005

(54) Raman laser with improved output power and lower sensitivity to the output coupler reflectivity

(75) Inventors: Florence Leplingard, Jouy-En-Josas (FR); Sophie Borne, d'Huison Longueville (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/990,440

(22) Filed: Nov. 18, 2004

(30) Foreign Application Priority Data
Jan. 8, 2004 (EP) 04 290 046.4

(51) Int. Cl. H01S 3/30

(52) U.S. Cl. 372/3

(57) ABSTRACT

It is proposed to use a Raman laser with a new optical resonant cavity for the Roman radiation λ_{RR}. Such resonant cavity is made out of an unpaired reflector r_{RR} with a reflecting wavelength corresponding to said Raman radiation λ_{RR}. The second reflector at the output needed to build an optical resonant cavity is advantageously defined by Rayleigh scattering to take place at least at a portion of the optical fiber between the reflector r_{RR} and the output of that Raman laser. With the use of the Rayleigh scattering as a complementary reflector to be associated with the unpaired reflector, it is then possible to obtain an optical resonant cavity for the Raman radiation λ_{RR} with an output reflectivity of less than 1% i.e. with optimized Raman radiation. Such Raman laser is particularly appropriated to be used as a second order Raman laser.

### TECHNICAL FIELD

The present invention relates to a Raman laser for the emission of Raman radiation and to an apparatus for Raman amplification comprising such Raman laser. Furthermore, it is related to a method for producing Raman radiation. The invention is based on a priority application EP 04 290 046.4 which is hereby incorporated by reference.

### BACKGROUND OF THE INVENTION

Optical fiber technology is currently applied in communication systems to transfer information, e.g., voice signals and data signals, over a long distances as optical signals. Over such long distances, however, the strength and quality of a transmitted optical signal diminishes. Accordingly, techniques have been developed to regenerate or amplify optical signals as they propagate along an optical fiber.

One well known amplifying technique exploits an effect called Raman scattering to amplify an incoming information bearing optical signal. Roman scattering describes the interaction of light with molecular vibration of the material for which the light propagates. Incident light scattered by molecules experience a downshift in frequency from the power bearing optical pump radiation. These downshift in frequency (or increase in wavelength) from the pump wavelength is referred to as the Stokes shift and the corresponding scattered light as Stokes line. The extend of the downshift and the shape of the Raman gain curve is determined by the molecular vibrational frequency modes of the transmission medium. In amorphous materials, such as silica, molecular vibrational frequencies spread into bands which overlap and provide a broadband wide gain curve.

Some initial pumping wavelength is advantageously used by injecting it together with a signal wavelength to be amplified into a Raman active transmission medium (e.g. fuse silicon). Providing that the signal wavelength to be amplified is within the Raman gain of said initial pumping wavelength (e.g., about 100 nm at 1550 nm in silica), then these signal wavelengths will experience optical gain generated by, and at the expense of, the initial pumping wavelength. In other words, these pumping wavelength amplifies the signal wavelength and, in so doing, it is diminished in strength. These gain process is called stimulated Raman scattering and is a well known technique for amplifying an optical signal.

The development of high intensity continuous waves radiation of a wavelength that is of interest for optical communications (e.g. around 1.55 μm) ends up in the use of cascaded Raman laser based on such stimulated Raman scattering. In U.S. Pat. No. 5,323,404 is described such an example of cascaded Raman laser. FIG. 1 illustrates such prior art with a Raman laser 10 comprising one or more pairs of reflectors (21, 21′, 22, 22′, 23, 23′, 24, 24′, 25, 25′), spaced apart, with reflectors of each pair having the same center wavelength. The reflectors typically are in line refractive index Bragg reflectors structured in SiO₂-based optical fiber with Ge containing core, each pair of reflectors providing an optical cavity in a fiber. Such an optical cavity include at least a portion of Raman fiber 17 where the stimulated Raman scattering which creates the gain will take place. Cavities that are neighbors in wavelengths differ in wavelengths usually by one Stokes shift, the longer wavelength of two consecutive Stokes shifts lying within the Raman gain spectrum of the previous Stokes shift. Radiation that is resonating in one of the optical cavities will be referred to as a Stokes lines.

To the Raman laser 10 is coupled through a coupler 16 some initial pump radiation at wavelength λ_{PO} coming from a pump source 15. Such Raman laser 10 is adapted for emission of radiation at its output 19 of a wavelength λ_{RR} longer than the initial pump radiation λ_{PO}.

In many potentially important applications of cascaded Raman laser, more than one reflector pair are used as in the example shown on FIG. 1. For instance, a laser having at its output a Raman radiation λ_{RR} of about 1.5 μm and using an initial pump radiation λ_{PO} of about 1.1 μm may require five reflector pairs (21, 21′), . . . (25, 25′). Not only is a Raman laser with so many reflectors difficult to manufacture since the two members of each pair of reflectors must have essentially the same center wavelength, but the unwanted attenuation due to the multiplicity of reflectors can be significant. For instance, a Stokes line can experienced up to 0.5 dB loss as the radiation passes through each output reflectors. And it is very difficult to get fiber Bragg grating with reflection coefficients as low as a few tens of percent. An alternative can be given by sparing the reflector at the output side of an optical resonant cavity possibly the one corresponding to the Raman radiation or the one of the seed radiation (see below for seed radiation). This is only possible if then that missing reflector is replaced by a cleaved fiber end. It is such cleaved end which will provide sufficient reflectivity (Fresnel reflectivity) of about 4% for setting up the optical resonant cavity. But, as known by the man skilled in the art it is not possible to reach a reflectivity of substantially less than 4% using Fresnel reflection.

### SUMMARY OF THE INVENTION

In view of the above, it is an object of the present invention to develop a Raman laser for the emission of Raman radiation with an optimized and possibly maximized output power. Furthermore, it is also an object to apply a method for producing such Raman radiation without implying a substantial increase in costs comparing to prior arts.

This object is achieved in accordance with the invention by the use of a Raman laser with a particular optical resonant cavity for the electromagnetic radiation of wavelength at the Raman radiation λ_{RR}. Such resonant cavity is made out of an unpaired reflector r_{RR} with a reflecting wavelength corresponding to said Raman radiation λ_{RR}. The second reflector at the output reflector needed to build an optical resonant cavity is advantageously defined by Rayleigh scattering to take place at least at a portion of the optical fiber between the reflector r_{RR} and the output of that Raman laser. Such Rayleigh scattering results from random localised variations of the molecular positions in glass that create random inhomogeneities of the reflective index. Such random inhomogeneities act as tiny scatter centers. Unlike in prior arts, Rayleigh's scattering will now no more be a noisy effect but in contrary be exploited to optimize the output of a Raman laser according to the invention. With the use of the Rayleigh scattering as a complementary reflector to be associated with the unpaired reflector, it is then possible to obtain an optical resonant cavity for the Raman radiation λ_{RR} with an output reflectivity of less than 1%. Advantageously, the reflectivity of such defined output reflector will be more in the range of few tens of percent possibly as small as 0.1%.

Such a Raman laser according to the invention is particularly appropriated to be used as a second order Raman laser with the Raman radiation λ_{RR} being a Stokes line obtained from the last but one applied cascaded stimulated Raman scattering. Such a second order Raman laser comprises at least a further optical resonant cavity defined by a pair of reflectors (r_{seed}, r′_{seed}), with a reflecting wavelength corresponding to a seed radiation λ_{seed}. Each such seed radiation corresponds to a Stokes line obtain from the last applied cascaded stimulated Raman scattering in the Raman laser according to the invention. Advantageously, the optical resonant cavity for the seed radiation comprises an output reflector r′_{seed} with a tunable reflectivity for its reflecting wavelength λ_{seed}. In such a way, it is possible to vary the power of the seed radiation preferably from 0 to more than 300 mW.

Only by the use of a Raman laser according to the invention, it is possible to control the power of the seed radiation with such high accuracy. Among other things, a reflectivity of less than 1% for the “output reflector” of the Raman radiation λ_{RR} allows to use an output reflector r′_{seed} for the seed radiation with a tunable reflectivity from 0 to more than 25%. In such a way can be advantageously optimised the control of the power of the seed radiation. This can be achieved by the use of a tunable fiber Bragg grating for the output reflector r′_{seed}.

Advantageous developments of the invention are described in the dependent claims, the following description and the drawings.

### DESCRIPTION OF THE DRAWINGS

An exemplary embodiment of the invention will now be explained further with the reference to the attached drawings in which:

FIG. 1 is a schematic view of a Raman laser together with a pump source according to the prior art;

FIG. 2 is a Raman laser according to the present invention;

FIG. 3 is a Raman laser used as a second order Raman laser according to the invention;

FIG. 4a is an example of the different Stokes shifts used for a second order Raman laser according to the invention.

FIG. 4b is a Raman gain for the 1351.5 nm wavelength according to FIG. 4a

### DETAILED DESCRIPTION OF PREFERRED EMBODIMENTS

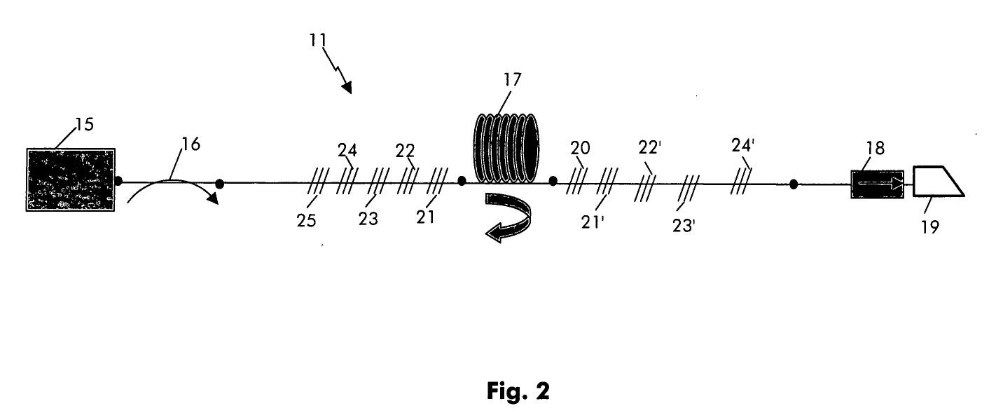

FIG. 2 shows a Raman laser 11 according to the invention. Such a Raman laser 11 comprises some lengths of optical fiber used as Raman fiber 17. That Raman fiber 17 is surrounded on both part by a number of reflectors (rᵢ, r′ᵢ). At the present example described in FIG. 2 are five reflectors 21, 22, . . . , 25 on the input side of the Raman laser 11 and five reflectors 20, 21′, . . . , 24′ on its output side. All these reflectors 20, 21, 21′, . . . , 24, 24′, 25, are preferably made by some fiber Bragg gratings structured on said optical fiber. But other kind of reflectors could be conceivable.

The Raman laser 11 is coupled on its input side via a coupler 16 with a pump source 15. This pump source will provide initial pump radiation at wavelength λ_{PO} into the Raman laser 11. On the output side of the Raman laser 11 is put an isolator 18 to protect it from any radiation coming from outside via its output. That output is characterized by a tilled cleaved end face 19 such to avoid a further undesirable reflector.

A Raman laser according to the invention is made of at least one (n=1) space apart pair (i=1, . . . , n) of reflectors (rᵢ, r′ᵢ). In the present case of FIG. 2 is depicted a Raman laser 11 with four (n=4) space apart pairs of reflectors (21, 21′), . . . , (24, 24′). The two reflectors of a pair have singular specific reflecting wavelengths λᵢ (i=1, . . . , 4). In such a way, each pair defines a different optical resonant cavity for electromagnetic radiation of wavelength at said respective reflecting wavelength λᵢ. Each of the optical resonant cavities comprises at least a portion of the Raman fiber 17 for the take place of stimulated Raman scattering. In the present case as shown on FIG. 2, all the four optical resonant cavities comprise almost the same portion of the Raman fiber 17. But also a successive i.e. sequential setup or overlapping to various degrees of the different optical resonant cavities with different portions of the Raman fiber 17 could be considered.

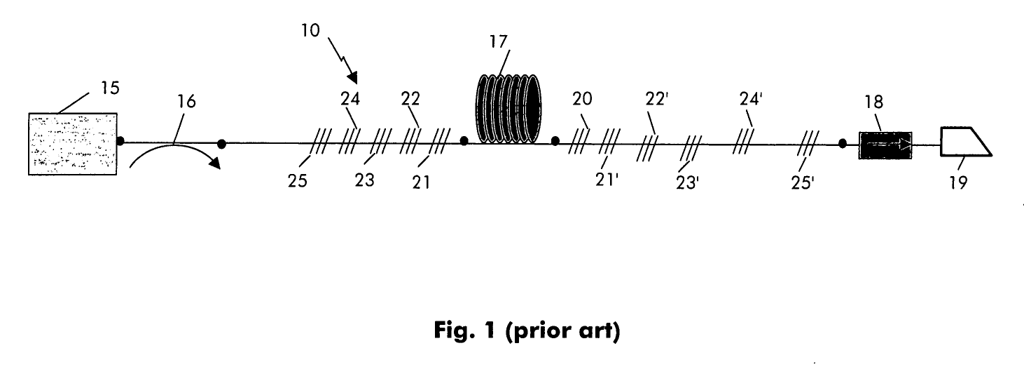

The optical resonant cavities are chosen such to build a cascaded Raman laser. Let's consider as an example a Raman laser 11 with an initial pump radiation at wavelength λ_{PO}=1117 nm. That initial pump radiation is provided by the pump source 15 and coupled by the coupler 16 into the Raman laser 11. At the output side of that Raman laser 11 is placed a reflector 20 with a specific reflecting wavelength corresponding to that initial pump radiation λ_{PO}. Latter will give a Stokes line at approximately 1167 nm due to stimulated Raman scattering taking place in the Raman fiber 17. The first pair of reflectors (21, 21′) of that cascaded Raman laser will be chosen with a reflecting wavelength at that value 1167 nm. That first optical resonant cavity will provide a Stokes line at 1223 nm corresponding to the reflecting wavelengths of the second pair of reflectors (22, 22′). The next two pairs of reflectors (23, 23′), (24, 24′) are defined with reflecting wavelengths respectively at 1284 nm, 1351 nm corresponding to successive Stokes line of that cascaded Raman laser. In the present case, the Raman laser 11 comprises at its input side a further reflector 25 at the reflecting wavelength 1427 nm. This reflector 25 is one of the two reflectors for the last used Stokes line giving the emission of the Raman radiation λ_{RR}=1427 nm of the Raman laser 11. The second reflector needed to build the corresponding optical resonant cavity for that electromagnetic radiation at λ_{RR} is no more given by a reflector as such but by the Rayleigh scattering to take place at least at a portion of said optical Raman fiber 17. The main difference between the Raman laser 11 according to the invention and a Raman laser 10 according to prior art (see FIG. 1) is based precisely on the replacement of the one reflector 25′ at the output side of the Raman laser 10 of the optical resonant cavity for the Raman radiation λ_{RR} by the use of the Rayleigh scattering. All the reflectors (20, 21, 21′, . . . , 24′, 25) of the Raman laser 11 on FIG. 2 are chosen with a reflectivity at around 99%. The reflectivity of Rayleigh scattering does not exceed 1% and is more in the range of 0.1%. In such a way, a Raman laser 11 according to the invention will have the big advantage to provide a Raman radiation λ_{RR} with a much higher power as in prior art. Indeed, the Raman laser 10 on FIG. 1 still includes the reflector 25′ with a reflectivity which can not be decreased below 5%. It is simply not possible to structure a reflector with a substantially less reflectivity than 5%.

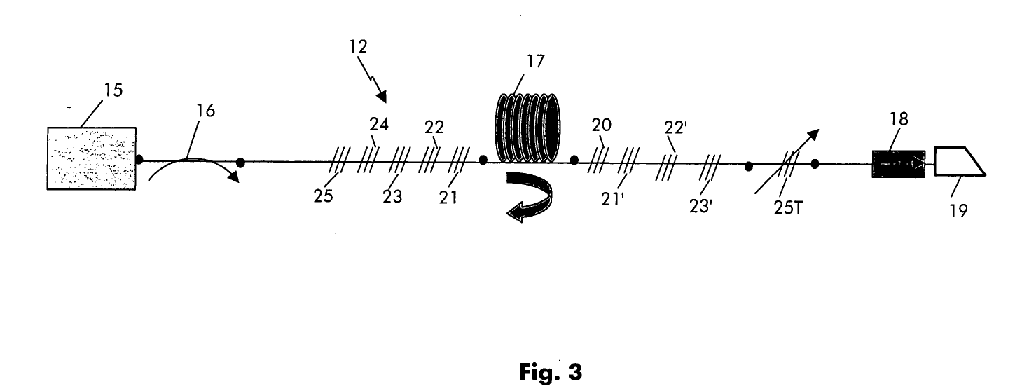

On FIG. 3 is shown a Raman laser 12 used according to the invention as a second order Raman laser. In a same way as the Raman laser 11 of FIG. 2, the Raman laser 12 is coupled via a coupler 16 to a pump source 15 for the initial pump radiation at wavelength λ_{P0}. Furthermore, the Raman laser 12 comprises a Raman fiber 17 surrounded by reflectors (20, 21, 21′, . . . , 23′, 24, 25T). The Raman laser 12 comprises further at its output an isolator 18 and a slanted cleaved output 19.

As a second order Raman laser, the Raman radiation λ_{RR} is given by a Stokes line obtain from the last but one applied cascaded stimulated Raman scattering. If we choose the same example as for FIG. 2, then the Raman radiation λ_{RR} is equal to 1351 nm. It is the resonant cavity with a reflecting wavelength at that Raman radiation which will be defined at the output side of the Raman laser 12 by the Rayleigh scattering instead of a reflector. The resonant cavity is defined at the input side of the Raman laser 12 by a usual reflector r_{RR}, 24.

The Raman laser 12 when used as a second order Raman laser comprises at least a further optical resonant cavity defined by a pair of reflectors (r_{seed}, r′_{seed}) with a reflecting wavelength corresponding to a seed radiation λ_{seed} of said second order Raman laser. The Raman laser 12 on FIG. 3 will provide a single seed radiation λ_{seed} at, if using same example as previously, 1427 nm. That seed radiation is given by the optical resonant cavity (25, 25T). The reflector 25T of that optical resonant cavity at the output side of the Raman laser 12 is preferably but not exclusively made by a tunable reflector allowing to vary the seed radiation power from 0 to more than 300 mW. Such a tunable reflector 25T could be given by a fiber Bragg grating with a reflectivity tuned using some e.g. heating procedure or bending procedure. In such a way, it is possible to obtain a reflector with a reflectivity tunable between 0 to more than 25%.

A Raman laser according to the invention when used as a second order Raman laser as shown on FIG. 3 will have the advantage to provide a Raman radiation at a high power due to the extremely low reflectivity around 0.1% of the Rayleigh scattering. This allows to tune easily the reflectivity of the output reflector r′_{seed} 25T around e.g. 25% to better control the power of the seed radiation at around few hundred mW.

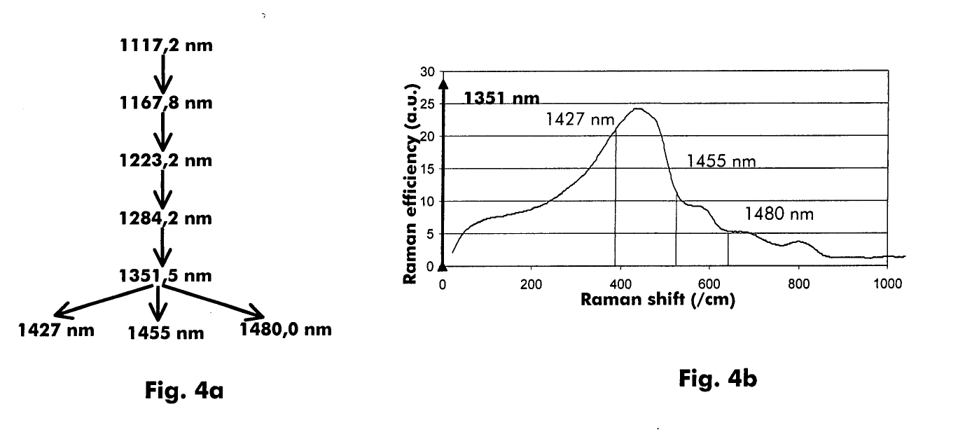

It is also conceivable to use a Raman laser as a second order Raman laser according to the invention with several seed radiations. On FIG. 4a is described such an example starting with an initial pump radiation at wavelength λ_{PO}=1117.2 nm. This radiation will give a first Stokes shift at 1167.8 nm followed in the cascaded Raman laser by further Stokes shift at 1223.2 nm, 1284.2 nm and 1351.5 nm. It is the last radiation of the cascaded radiations i.e. 1351.5 nm which will be used as the Raman radiation λ_{RR}, i.e. being given by an optical resonant cavity defined by a reflector r_{RR} at the input side of the Raman laser and by Rayleigh scattering to take place in the Raman fiber of that Raman laser. On FIG. 4a is shown that three further seed radiations namely at 1427.0 nm, 1455.0 nm, 1480.0 nm are extracted from that Raman laser. This is possible by using three different optical resonant cavities similar to the optical cavity (25, 25T) shown on FIG. 3. The respective reflecting wavelengths of three optical resonant cavities must be defined within the Raman shift given by the Raman radiation i.e. at a wavelength λ_{RR} equal approximately to 1351.5 nm itself given by the Stokes line obtained from the last but one applied cascaded stimulated Raman scattering.

Due to the extremely low reflectivity of the Rayleigh scattering used as the reflector at the output of the Raman laser according to the invention for the Raman radiation, it is important to protect such a Raman laser using an isolator 18 from any possible noisy radiation. Such radiation are usually present on any optical systems and could enter in the Raman laser when latter is installed into an apparatus using its Raman radiation as Raman pump radiation.

1. A Raman laser for the emission of Raman radiation at a wavelength λ_{RR} comprising
a length of optical fiber;
a pump source for introducing initial pump radiation at wavelength λ_{P0} into said optical fiber;
a plurality space apart pairs (i=1, . . . n with n≧1) of reflectors (rᵢ, rᵢ′), the two reflectors of a pair with similar specific reflecting wavelength λᵢ such that each pair defining a different optical resonant cavity for electromagnetic radiation of wavelength at said respective reflecting wavelength λ₁, with the optical resonant cavities comprising at least a portion of said optical fiber for the take place of stimulated Raman scattering, the optical resonant cavities being chosen such to build a cascaded Raman laser,
wherein the optical resonant cavity for electromagnetic radiation of wavelength at the Raman radiation λ_{RR} is made out at one side of a reflector (r_{RR}) with a reflecting wavelength corresponding to said Raman radiation λ_{RR} and at the other output side of a reflector being defined by Rayleigh scattering to take place at least at a portion of said optical fiber with for such defined output reflector a reflectivity of less than 1%.

2. The Raman laser according to claim 1 wherein all the reflectors of the optical resonant cavities except for the one defined by the Rayleigh scattering are defined by fiber Bragg gratings preferably structured on said optical fiber.

3. The Raman laser according to claim 1 wherein it is a second order Raman laser comprising at least a further optical resonant cavity defined by a pair of reflectors (r_{seed}, r′_{seed}) with a reflecting wavelength corresponding to a seed radiation λ_{seed} of said second order Raman laser such that the Raman radiation λ_{RR} being a Stokes line obtained from the last but one applied cascaded stimulated Raman scattering and the seed radiation λ_{seed} being a Stokes line obtained from the last applied cascaded stimulated Raman scattering.

4. The Raman laser according to claim 3 wherein the optical resonant cavity for the seed radiation comprises an output reflector (r′_{seed}) with a tunable reflectivity for its reflecting wavelength λ_{seed} obtained by some external action on the corresponding fiber portion which allows to vary the seed radiation power preferably from 0 to more than 300 mW.

5. The Raman laser according to claim 4 wherein said output reflector (r′_{seed}) is a fiber Bragg grating with a tunable reflectivity for its reflectivity wavelength λ_{seed} from 0 to more than 25%.

6. An apparatus comprising a Raman laser according to claim 1.

7. A method for producing Raman radiation at a wavelength λ_{RR} using a Raman laser by applying the steps of:
introducing initial pumping radiation at wavelength λ_{P0} into an optical fiber of said Raman laser;
applying said initial pumping radiation λ_{P0} on optical resonant cavities of said Raman laser for a cascaded stimulated Raman scattering while each of said optical resonant cavities being made by a pair (i=1, . . . n with n≧1) of reflectors (rᵢ, rᵢ′) with similar specific reflecting wavelength λᵢ and in between at least a portion of said optical fiber for the take place of the stimulated Raman scattering,
whereby extracting out of said Raman laser the Raman radiation λ_{RR} from an optical resonant cavity made out at one side of a reflector (r_{RR}) with a reflecting wavelength corresponding to said Raman radiation λ_{RR} and at the other output side of a reflector being defined by Rayleigh scattering to take place at least at a portion of said optical fiber with for such defined output reflector a reflectivity of less than 1%.

8. The method for producing Raman radiation according to claim 7 whereby using said Raman laser as a second order Raman laser with the Raman radiation λ_{RR} to be a Stokes line obtained from the last but one applied cascaded stimulated Raman scattering and a seed radiation λ_{seed} to be extracted from an optical resonant cavity defined by a pair of reflectors (r_{seed}, r′_{seed}) with reflecting wavelength corresponding to seed radiation λ_{seed} being a Stokes line obtained from the last applied cascaded stimulated Raman scattering.

9. The method for producing Raman radiation according to claim 8 whereby optimising the output seed radiation power preferably from 0 to more than 300 mW using the optical resonant cavity for the seed radiation with an output reflector (r′_{seed}) defined by a tunable reflectivity for its reflecting wavelength λ_{seed}.
